(19) United States
(12) Patent Application Publication
(10) Pub. No.: US 2024/0077655 A1
(43) Pub. Date: Mar. 7, 2024

(54) OPTICAL ASSEMBLY AND OPTICAL APPARATUS

(71) Applicant: Shphotonics Ltd, Suzhou (CN)

(72) Inventors: Shanfeng QIU, Suzhou (CN); Lei SUN, Suzhou (CN)

(21) Appl. No.: 18/356,938

(22) Filed: Jul. 21, 2023

(30) Foreign Application Priority Data
Sep. 1, 2022 (CN) 202222344078.8

(51) Int. Cl. G02B 3/00; G02B 1/00; G02B 17/08; G02B 27/10; H04N 23/55; H04N 23/56

(52) U.S. Cl. CPC G02B 3/0062; G02B 1/002; G02B 17/086; G02B 27/106; H04N 23/55; H04N 23/56; G02B 2207/101

(57) ABSTRACT

An optical assembly includes a metalens. The metalens includes a nanostructure configured to cause light incident on the metalens to be separated by the metalens into deflection light and zero-order diffraction light. An emission direction of the deflection light is different from an emission direction of the zero-order diffraction light.

### CROSS-REFERENCE TO RELATED APPLICATION

This application claims priority to Chinese Application No. 202222344078.8, filed on Sep. 1, 2022, the entire content of which is incorporated herein by reference.

### TECHNICAL FIELD

The present disclosure relates to the optical apparatus technology field and, in particular, to an optical assembly and an optical apparatus.

### BACKGROUND

Metasurface and metalens have become popular optical cutting-edge technologies and are the most rapidly developing and disruptive new technologies in the fields of optics and photonics. Metalens is broadly applied in security monitoring, consumer electronics, industrial applications, medical devices, aerospace, and automotive electronics.

Imaging or light emission quality using metalenses needs to be improved.

### SUMMARY

Embodiments of the present disclosure provide an optical assembly including a metalens. The metalens includes a nanostructure configured to cause light incident on the metalens to be separated by the metalens into deflection light and zero-order diffraction light. An emission direction of the deflection light is different from an emission direction of the zero-order diffraction light.

Embodiments of the present disclosure provide an optical apparatus including an optical assembly. The optical assembly includes a metalens. The metalens includes a nanostructure configured to cause light incident on the metalens to be separated by the metalens into deflection light and zero-order diffraction light. An emission direction of the deflection light is different from an emission direction of the zero-order diffraction light.

### BRIEF DESCRIPTION OF THE DRAWINGS

FIG. 1 is a schematic diagram of an optical assembly (light-emitting assembly) according to some embodiments of the present disclosure.

FIG. 2 is a schematic diagram of an optical assembly (light-emitting assembly) according to some embodiments of the present disclosure.

FIG. 3 is a schematic diagram of an optical assembly (light-emitting assembly) according to some embodiments of the present disclosure.

FIG. 4 is a schematic diagram of an optical assembly (light-emitting assembly) according to some embodiments of the present disclosure.

FIG. 5 is a schematic diagram of an optical assembly (imaging assembly) according to some embodiments of the present disclosure.

FIG. 6 is a schematic diagram of an optical assembly (imaging assembly) according to some embodiments of the present disclosure.

FIG. 7 is a schematic diagram of an optical assembly (imaging assembly) according to some embodiments of the present disclosure.

FIG. 8 is a schematic diagram of an optical assembly (imaging assembly) according to some embodiments of the present disclosure.

FIG. 9 is a schematic diagram of an optical apparatus according to some embodiments of the present disclosure.

Reference numerals:

| | | |
|---|---|---|
| 100 Optical assembly | 110 Light-emitting | 120 Metalens |
| | assembly | |
| 1200 Nanostructure | 130 Imaging assembly | 140 Light source emitter |
| 150 Deflection light | 151 First deflection | 152 Second deflection |
| | light | light |
| 160 Zero-order | 161 First zero-order | |
| diffraction light | diffraction light | |
| 162 Second zero-order | 170 Image sensor | |
| diffraction light | | |
| 121 First metalens | 122 Second metalens | 200 Optical apparatus |

### DETAILED DESCRIPTION OF THE EMBODIMENTS

In the following, some example embodiments are described. As those skilled in the art would recognize, the described embodiments can be modified in various manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers. In this disclosure, if a light beam encounters a first element and then reaches a second element, the second element is referred to as being downstream the first element or downstream the first element in an optical path, and correspondingly the first element is referred to as being upstream the second element or upstream the second element in the optical path.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of manufacturing techniques and/or tolerances, can be expected. Thus, embodiments of the present disclosure should not be interpreted as being limited to the specific shapes of regions illustrated in the drawings, but are to include deviations in shapes that result, for example, from manufacturing. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

Metasurface refers to an artificial two-dimensional material. A basic structure unit of metasurface is a nanostructure unit with a size in an order of nanometers and smaller than a working wavelength. Metasurface can realize flexible and effective control of the characteristics, such as propagation direction, polarization mode, amplitude, and phase, of electromagnetic waves. Metasurface can also have an ultra-light characteristic. A metasurface optical device made based on the metasurface device can have good optical performance, small volume, and high integration compared to a conventional optical device. A metalens can be an optical device based on the metasurface technology in a plane shape.

Metalens can have high flexibility in optical modulation. However, in practical applications, a part of light can be directly emitted when passing through the metalens without being modulated by the metalens, which is known as a zero-order diffraction effect. The part of the light can be referred to as the zero-order diffraction light. The zero-order diffracted effect can interfere with an optical path to cause abnormality in an imaging system (e.g., an obvious bright spot on a captured image) or interfere quality of a light spot pattern generated by the light-emitting system (e.g., interfere uniformity of a light spot array).

Embodiments of the present disclosure provide an optical assembly and an optical apparatus to improve quality of imaging or light emission using metalens.

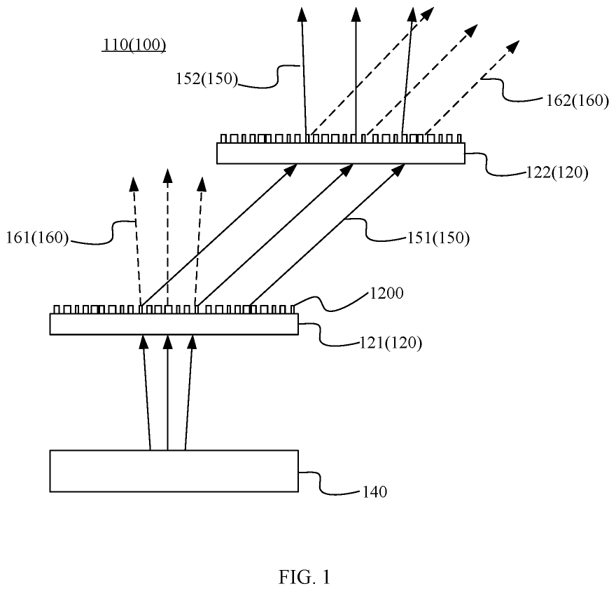

As shown in FIG. 1, an optical assembly 100 of some embodiments of the present disclosure includes at least one metalens 120. The metalens 120 includes a nanostructure 1200. The nanostructure 1200 can be configured to separate incident light of the metalens 120 into deflection light 150 and zero-order diffraction light 160 by the metalens 120. An emission direction of the deflection light 150 can be different from an emission direction of the zero-order diffraction light 160.

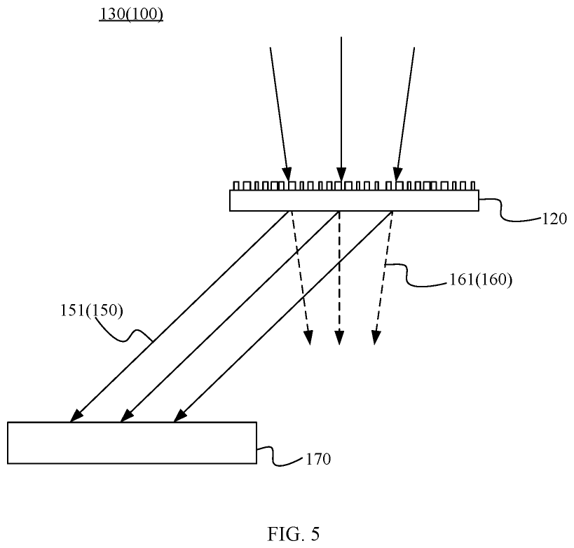

In some embodiments of the present disclosure, the specific product type of the optical assembly 100 is not limited. For example, the optical assembly can include a light-emitting assembly 110 including a light source emitter 140 (e.g., can be applied to a laser emitter or a projection apparatus) as shown in FIG. 1 or an imaging assembly 130 including an image sensor 170 (e.g., can be applied to a mobile terminal, a virtual reality apparatus, or an augmented reality apparatus) as shown in FIG. 5.

In some embodiments of the present disclosure, the metalens 120 can also be configured to simultaneously have effects of dispersion and convergence (or divergence) for the received light to have a multi-functional modulation effect for the light.

The optical assembly 100 can include one or more metalenses 120 and another optical element, for example, one or more of a focusing element, a divergence element, a diffractive grating element, a transmissive grating element, a polarization element, a filter element, and a dispersion element. Types, specifications, and quantities of the optical elements are not limited in the present disclosure. For example, the convergence element can be a convex lens, and the divergence element can be a concave lens. In some embodiments, one or more of these optical elements can also include metasurface structures. In addition, the optical assembly 100 can include an installation structure for supporting and positioning the optical elements.

In the optical assembly 100 of embodiments of the present disclosure, with the metasurface design of the metalens 120, the emitted light can be separated into the deflection light 150 and the zero-order diffraction light 160 with different emission directions. The deflection light 150 can be deflected according to a designed path. In embodiments of the present disclosure, the deflection light 150 can be directed to a target area, and the zero-order diffraction light 160 can be directed to outside of the target area. Thus, the interference of the zero-order diffracted effect to the optical path can be reduced. Thus, the imaging or light emission quality using the metalens can be improved.

As shown in FIG. 1, in some embodiments, the optical assembly 100 is the light-emitting assembly 110. The light-emitting assembly 110 includes the light source emitter 140 optically coupled to at least one metalens 120.

As shown in FIG. 1, in some embodiments, the at least one metalens 120 includes a first metalens 121 and a second metalens 122. The first metalens 121 and the second metalens 122 are arranged oppositely to each other and staggered. The first metalens 121 is arranged between the light source emitter 140 and the second metalens 122. The light source emitter 140, the first metalens 121, and the second metalens 122 can be configured to cause the light emitted from the light source emitter 140 and incident on the first metalens 121 to be transmitted and separated by the first metalens 121 into first deflection light 151 and first zero-order diffraction light 161. The first deflection light 151 can be directed to the second metalens 122. The first zero-order diffraction light 161 can be directed to outside of the second metalens 122. The light source emitter 140, the first metalens 121, and the second metalens 122 can be further configured to cause the first deflection light 151 from the first metalens 121 to the second metalens 122 to be transmitted and separated by the second metalens 122 into second deflection light 152 and second zero-order diffraction light 162. The second deflection light 152 can be directed to the target area, and the second zero-order diffraction light 162 can be directed to outside of the target area. The target area can be, for example, an area where the light-emitting assembly 110 is expected to generate a light spot pattern.

The light-emitting assembly of embodiments of the present disclosure can be configured to direct the deflected transmission light to the target area and direct the zero-order diffraction light to outside of the target area. Thus, the interference from the zero-order diffraction effect on the light-emitting optical path can be reduced, and the light emission quality using the metalens can be improved.

Because of the advantages of metasurface, such as ultra-light, ultra-thin, and planarized, the first metalens 121 and the second metalens 122 of embodiments of the present disclosure can also be configured to fold the optical path. Thus, the light-emitting assembly 110 can be light, and the packaging difficulty of the light-emitting assembly 110 can also be greatly lowered.

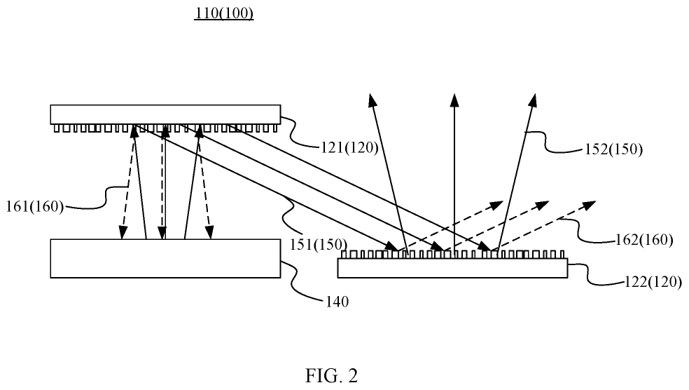

In some embodiments, as shown in FIG. 2, the light-emitting assembly 110 includes two metalenses 120, i.e., the first metalens 121 and the second metalens 122. The first metalens 121 and the second metalens 122 are arranged oppositely to each other and staggered. The second metalens 122 and the light source emitter 140 are arranged on a same side of the first metalens 121. The light source emitter 140, the first metalens 121, and the second metalens 122 can be configured to cause the light emitted from the light source emitter 140 and incident on the first metalens 121 to be reflected by the first metalens 121 and the incident light from the light source emitter 140 to be reflected and separated by the first metalens 121 into the first deflection light 151 and the first zero-order diffraction light 161. The first deflection light 151 can be directed to the second metalens 122. The first zero-order diffraction light 161 can be directed to outside of the second metalens 122. The light source emitter 140, the first metalens 121, and the second metalens 122 can be further configured to cause the first deflection light 151 from the first metalens 121 to the second metalens 122 to be reflected and separated by the second metalens 122 into the second deflection light 152 and the second zero-order diffraction light 162. The second deflection light 152 can be directed to the target area. The second zero-order diffraction light 162 can be directed to outside of the target area.

Similarly, the light-emitting assembly of embodiments of the present disclosure can be configured to direct the deflected transmission light to the target area and direct the zero-order diffraction light to outside of the target area. Thus, the interference from the zero-order diffraction effect on the light-emitting optical path can be reduced, and the light emission quality can be improved. In addition, the first metalens and the second metalens can be further configured to fold the optical path. Thus, the light-emitting assembly can be light, and the packaging difficulty of the light-emitting assembly can be greatly reduced.

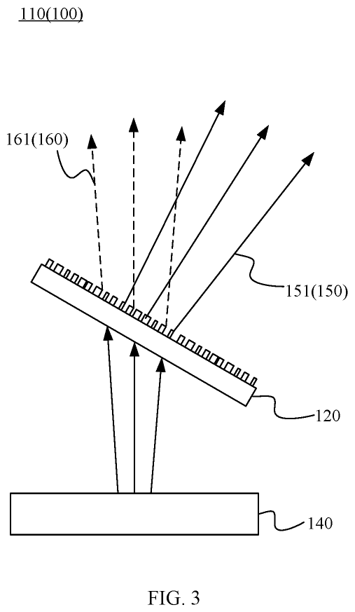

In some embodiments of the present disclosure, as shown in FIG. 3, the light-emitting assembly 110 includes one metalens 120. The metalens 120 has an included angle with the light source emitter 140 (i.e., the metalens 120 is inclined with respect to the light source emitter 140). The metalens 120 and the light source emitter 140 can be configured to cause the light emitted from the light resource emitter 140 and incident on the metalens 120 to be transmitted and separated by the metalens 120 into the first deflection light 151 and the first zero-order diffraction light 161. The first deflection light 151 can be directed to the target area. The first zero-order diffraction light 161 can be directed to outside of the target area.

The light-emitting assembly of embodiments of the present disclosure can be configured to direct the deflected transmission light to the target area and direct the zero-order diffraction light to outside of the target area. Thus, the interference of the zero-order diffraction effect on the light-emitting path can be reduced.

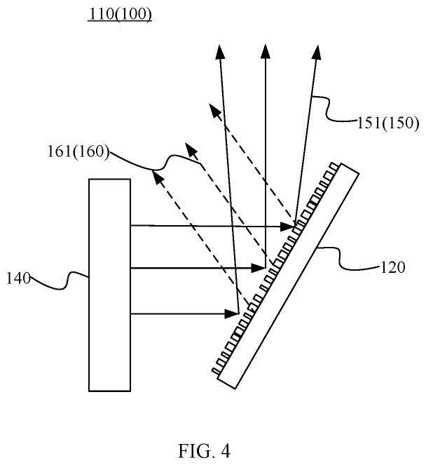

In embodiments of the present disclosure, as shown in FIG. 4, the light-emitting assembly 110 includes one metalens 120. The metalens 120 has an included angle with the light source emitter 140 (i.e., the metalens 120 is inclined to the light source emitter 140). The metalens 120 and the light source emitter 140 can be configured to cause the light emitted from the light resource emitter 140 and incident on the metalens 120 to be reflected and separated by the metalens 120 into the first deflection light 151 and the first zero-order diffraction light 161. The first deflection light 151 can be directed to the target area. The first zero-order diffraction light 161 can be directed to outside of the target area.

The light-emitting assembly of embodiments of the present disclosure can be configured to direct the deflected transmission light to the target area and direct the zero-order diffraction light to outside of the target area. Thus, the interference of the zero-order diffraction effect on the light-emitting path can be reduced.

In some embodiments, as shown in FIG. 5, the optical assembly 100 is an imaging assembly 130. The imaging assembly 130 includes an image sensor 170. The image sensor is optically coupled to at least one metalens 120. In some embodiments, the at least one metalens 120 includes one metalens 120. The image sensor 170 and the metalens 120 can be arranged oppositely to each other and staggered. The image sensor 170 and the metalens 120 can be configured to cause the light incident on the metalens 120 to be transmitted and separated by the metalens 120 into the first deflection light 151 and the first zero-order diffraction light 161. The first deflection light 151 can be directed to the image sensor 170, and the first zero-order diffraction light 161 can be directed to outside of the image sensor 170.

The imaging assembly of embodiments of the present disclosure can direct the deflected transmission light to the target area and direct the zero-order diffraction light to outside of the target area. Thus, the interference from the zero-order diffraction effect on the light-emitting optical path can be reduced, and the light emission quality can be improved.

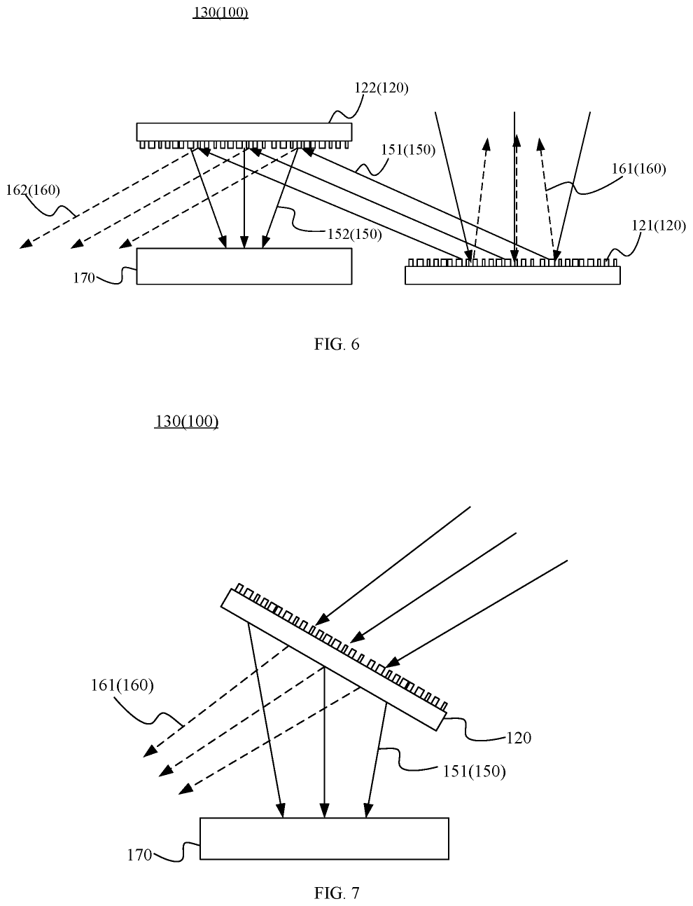

In some embodiments, as shown in FIG. 6, the optical assembly 100 is an imaging assembly 130. The imaging assembly 130 includes the image sensor 170 and two metalenses 120 above, i.e., the first metalens 121 and the second metalens 122. The first metalens 121 and the second metalens 122 are arranged oppositely to each other and staggered. The image sensor 170 and the first metalens 121 are on the same side of the second metalens 122. The image sensor 170, the first metalens 121, and the second metalens 122 can be configured to cause the light incident on the first metalens 121 to be reflected and separated by the first metalens 121 into the first deflection light 151 and the first zero-order diffraction light 161. The first deflection light 151 can be directed to the second metalens 122, and the first zero-order diffraction light 161 can be directed to outside of the second metalens 122. The image sensor 170, the first metalens 121, and the second metalens 122 can be further configured to cause the first deflection light 151 from the first metalens 121 to the second metalens 122 to be reflected and separated into the second deflection light 152 and the second zero-order diffraction light 162. The second deflection light 152 can be directed to the image sensor 170, and the second zero-order diffraction light 162 can be directed to outside of the image sensor 170.

The imaging assembly of embodiments of the present disclosure can direct the deflected transmission light to the target area and direct the zero-order diffraction light to outside of the target area. Thus, the interference from the zero-order diffraction effect on the light-emitting optical path can be reduced, and the light emission quality can be improved. In addition, with the first metalens and the second metalens, the optical path can be folded. Thus, the imaging assembly can be light, and the packaging difficulty of the imaging assembly can be greatly reduced.

In some embodiments, as shown in FIG. 7, the optical assembly 100 is the imaging assembly 130. The imaging assembly 130 includes the image sensor 170 and the metalens 120 above. The metalens 120 has an included angle with the image sensor 170 (i.e., the metalens 120 is inclined to the image sensor 170). The metalens 120 and the image sensor 170 can be configured to cause the light incident on the metalens 120 to be transmitted and separated by the metalens 120 into the first deflection light 151 and the first zero-order diffraction light 161. The first deflection light 151 can be directed to the image sensor 170, and the first zero-order diffraction light 161 can be directed to outside of the image sensor 170.

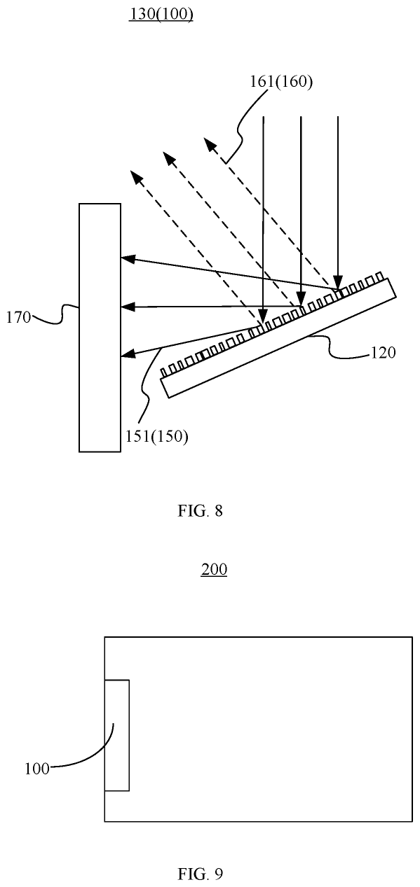

In some embodiments, as shown in FIG. 8, the optical assembly 100 is the imaging assembly 130. The imaging assembly 130 includes the image sensor 170 and the above metalens 120. The metalens 120 has an included angle with the image sensor 170 (i.e., the metalens 120 is inclined to the image sensor 170). The metalens 120 and the image sensor 170 can be configured to cause the light incident on the metalens 120 to be reflected and separated by the metalens 120 into the first deflection light 151 and the first zero-order diffraction light 161. The first deflection light 151 can be directed to the image sensor 170, and the first zero-order diffraction light 161 can be directed to outside of the image sensor 170.

The imaging assemblies above can be configured to direct the deflection light to the target area and direct the zero-order diffraction light to outside of the target area. Thus, the interference of the zero-order diffraction effect on the imaging optical path can be reduced.

As shown in FIG. 9, embodiments of the present disclosure provide an optical apparatus 200. The optical apparatus 200 includes the above optical assembly 100. The optical apparatus 200 can include but is not limited to a camera of a mobile terminal, a virtual reality apparatus, an augmented reality apparatus, or a light-emitting device. The optical apparatus 200 can have high imaging or light-emitting quality.

The present disclosure provides different embodiments or examples for implementing the present disclosure. The different embodiments or examples are exemplary and are not intended to limit the scope of the present disclosure. Those skilled in the art can think of various modifications and replacements based on the contents of the specification. These modifications and replacements are within the scope of the present disclosure. Thus, the scope of the present invention is subjected to the appended claims.

What is claimed is:

1. An optical assembly comprising:
a metalense including a nanostructure configured to cause light incident on the metalens to be separated by the metalens into deflection light and zero-order diffraction light, an emission direction of the deflection light being different from an emission direction of the zero-order diffraction light.

2. The optical assembly of claim 1, further comprising:
a light source emitter optically coupled to the metalens.

3. The optical assembly of claim 2,
wherein the metalens is a first metalens;
the optical assembly further comprising:
a second metalens;
wherein:
the first metalens and the second metalens are arranged oppositely to each other and staggered;
the first metalens is arranged between the light source emitter and the second metalens; and
the light source emitter, the first metalens, and the second metalens are configured to cause:
light emitted from the light source emitter and incident on the first metalens to be transmitted and separated by the first metalens into first deflection light and first zero-order diffraction light, the first deflection light being directed to the second metalens, and the first zero-order diffraction light being directed to outside of the second metalens; and
the first deflection light to be transmitted and separated by the second metalens into second deflection light and second zero-order diffraction light, the second deflection light being directed to a target area, and the second zero-order diffraction light being directed to outside of the target area.

4. The optical assembly of claim 2,
wherein the metalens includes a first metalens;
the optical assembly further comprising:
a second metalens;
wherein:
the first metalens and the second metalens are arranged oppositely to each other and staggered;
the second metalens and the light source emitter are arranged on a same side of the first metalens; and
the light source emitter, the first metalens, and the second metalens are configured to cause:
light emitted from the light source emitter and incident on the first metalens to be reflected and separated by the first metalens into first deflection light and first zero-order diffraction light, the first deflection light being directed to the second metalens, and the first zero-order diffraction light being directed to outside of the second metalens; and
the first deflection light to be reflected and separated by the second metalens into second deflection light and second zero-order diffraction light, the second deflection light being directed to a target area, and the second zero-order diffraction light being directed to outside of the target area.

5. The optical assembly of claim 2, wherein:
the metalens has an included angle with the light source emitter; and
the light source emitter and the metalens are configured to cause:
light emitted from the light source emitter and incident on the metalens to be transmitted and separated by the metalens into deflection light and zero-order diffraction light, the deflection light being directed to a target area, and the zero-order diffraction light being directed to outside of the target area; or
the light emitted from the light source emitter and incident on the metalens to be reflected and separated by the metalens into the deflection light and the zero-order diffraction light, the deflection light being directed to the target area, and the zero-order diffraction light being directed to outside of the target area.

6. The optical assembly of claim 1, further comprising:
an image sensor optically coupled to the metalens.

7. The optical assembly of claim 6, wherein:
the image sensor and the metalens are arranged oppositely to each other and staggered; and
the image sensor and the metalens are configured to cause light incident on the metalens to be transmitted and separated by the metalens into deflection light and zero-order diffraction light, the deflection light being directed to the image sensor, and the zero-order diffraction light being directed to outside of the image sensor.

8. The optical assembly of claim 6, wherein:
wherein the metalens is a first metalens;
the optical assembly further comprising:
a second metalens;
wherein:
the first metalens and the second metalens are arranged oppositely to each other and staggered;
the first metalens and the image sensor are on a same side of the second metalens; and
the image sensor, the first metalens, and the second metalens are configured to cause:
light incident on the first metalens to be reflected and separated by the first metalens into first deflection light and first zero-order diffraction light, the first deflection light being directed to the second metalens, and the first zero-order diffraction light being directed to outside of the second metalens; and
the first deflection light from the first metalens to the second metalens to be reflected and separated by the second metalens into second deflection light and second diffraction light, the second deflection light being directed to the image sensor, and the second zero-order diffraction light being directed to outside of the image sensor.

9. The optical assembly of claim 6, wherein:
the metalens has an included angle with the image sensor; and
the image sensor and the metalens are configured to cause:
light incident on the metalens to be transmitted and separated by the metalens into deflection light and zero-order diffraction light, the deflection light being directed to the image sensor, and the zero-order diffraction light being directed to outside of the image sensor; or
the light incident on the metalens to be reflected and separated by the metalens into the deflection light and the zero-order diffraction light, the deflection light being directed to the image sensor, and the zero-order diffraction light being directed to outside of the image sensor.

10. An optical apparatus comprising:
an optical assembly including:
a metalense including a nanostructure configured to cause light incident on the metalens to be separated by the metalens into deflection light and zero-order diffraction light, an emission direction of the deflection light being different from an emission direction of the zero-order diffraction light.

11. The optical apparatus of claim 10, wherein the optical assembly includes:
a light source emitter optically coupled to the metalens.

12. The optical apparatus of claim 11, wherein:
the metalens is a first metalens;
the optical assembly further includes a second metalens;
the first metalens and the second metalens are arranged oppositely to each other and staggered;
the first metalens is arranged between the light source emitter and the second metalens; and
the light source emitter, the first metalens, and the second metalens are configured to cause:
light emitted from the light source emitter and incident on the first metalens to be transmitted and separated by the first metalens into first deflection light and first zero-order diffraction light, the first deflection light being directed to the second metalens, and the first zero-order diffraction light being directed to outside of the second metalens; and
the first deflection light to be transmitted and separated by the second metalens into second deflection light and second zero-order diffraction light, the second deflection light being directed to a target area, and the second zero-order diffraction light being directed to outside of the target area.

13. The optical apparatus of claim 11, wherein:
the metalens is a first metalens;
the optical assembly further includes a second metalens;
the first metalens and the second metalens are arranged oppositely to each other and staggered;
the second metalens and the light source emitter are arranged on a same side of the first metalens; and
the light source emitter, the first metalens, and the second metalens are configured to cause:
light emitted from the light source emitter and incident on the first metalens to be reflected and separated by the first metalens into first deflection light and first zero-order diffraction light, the first deflection light being directed to the second metalens, and the first zero-order diffraction light being directed to outside of the second metalens; and
the first deflection light to be reflected and separated by the second metalens into second deflection light and second zero-order diffraction light, the second deflection light being directed to a target area, and the second zero-order diffraction light being directed to outside of the target area.

14. The optical apparatus of claim 11, wherein:
the metalens has an included angle with the light source emitter; and
the light source emitter and the metalens are configured to cause:
light emitted from the light source emitter and incident on the metalens to be transmitted and separated by the metalens into deflection light and zero-order diffraction light, the deflection light being directed to a target area, and the zero-order diffraction light being directed to outside of the target area; or
the light emitted from the light source emitter and incident on the metalens to be reflected and separated by the metalens into the deflection light and the zero-order diffraction light, the deflection light being directed to the target area, and the zero-order diffraction light being directed to outside of the target area.

15. The optical apparatus of claim 10, wherein the optical assembly includes:
an image sensor optically coupled to the metalens.

16. The optical apparatus of claim 15, wherein:
the image sensor and the metalens are arranged oppositely to each other and staggered; and
the image sensor and the metalens are configured to cause light incident on the metalens to be transmitted and separated by the metalens into deflection light and zero-order diffraction light, the deflection light being directed to the image sensor, and the zero-order diffraction light being directed to outside of the image sensor.

17. The optical apparatus of claim 15, wherein:
the metalens is a first metalens;
the optical assembly further includes a second metalens;
the first metalens and the second metalens are arranged oppositely to each other and staggered;
the first metalens and the image sensor are on a same side of the second metalens; and
the image sensor, the first metalens, and the second metalens are configured to cause:
light incident on the first metalens to be reflected and separated by the first metalens into first deflection light and first zero-order diffraction light, the first deflection light being directed to the second metalens, and the first zero-order diffraction light being directed to outside of the second metalens; and
the first deflection light from the first metalens to the second metalens to be reflected and separated by the second metalens into second deflection light and second diffraction light, the second deflection light being directed to the image sensor, and the second zero-order diffraction light being directed to outside of the image sensor.

18. The optical apparatus of claim 15, wherein:
the metalens has an included angle with the image sensor; and
the image sensor and the metalens are configured to cause:
light incident on the metalens to be transmitted and separated by the metalens into deflection light and zero-order diffraction light, the deflection light being directed to the image sensor, and the zero-order diffraction light being directed to outside of the image sensor; or
the light incident on the metalens to be reflected and separated by the metalens into the deflection light and the zero-order diffraction light, the deflection light being directed to the image sensor, and the zero-order diffraction light being directed to outside of the image sensor.
